(19) United States
(12) Patent Application Publication
(10) Pub. No.: US 2005/0034245 A1
(43) Pub. Date: Feb. 17, 2005

(54) Spiral system reactor for the treatment of hides and skins

(76) Inventor: Luis Cesio Caccialli, Montevideo (UY)

Correspondence Address: QUARLES & BRADY LLP, 411 E. WISCONSIN AVENUE, SUITE 2040, MILWAUKEE, WI, 53202-4497, US

(21) Appl. No.: 10/855,475

(22) Filed: May 27, 2004

(30) Foreign Application Priority Data
Aug. 11, 2003 (UY) 27.934

(51) Int. Cl. C14C 1/00

(52) U.S. Cl. 8/94.15

(57) ABSTRACT

A device for the process of tanning hides and skins, comprising a cylindrical body and crosspieces of appropriate shape and in appropriate arrangement inside it, the particular features of the shape and operation of said device resulting in an increased load in Kgs. Of hides and skins in each operation cycle, a decrease in requirements of chemicals applied in proportion to the load being processed, a considerable decrease in processing time, and lower water requirements.

The technical innovation for which we claim authorship and patentability, refers to a device for the tanning process of hides and/or skins, the particular features of the shape and operation of said device resulting in an increased load in Kgs. of hides and skins in each operation cycle, a decrease in requirements of chemicals applied in proportion to the load being processed, a considerable decrease in processing time and lower water requirements.

The device of this invention, to be used in steeping, hair scraping, pickling, tanning, retanning, currying (greasing), dyeing, dressing and beating processes on hides and skins, may operate at variable speeds (from 0.5-0.8 up to 18-20 rpm) according to the various stages in the process for any intended purpose.

Moreover, its efficient mechanical working produces an excellent mixing of solid and liquid elements, thus optimizing homogenization results.

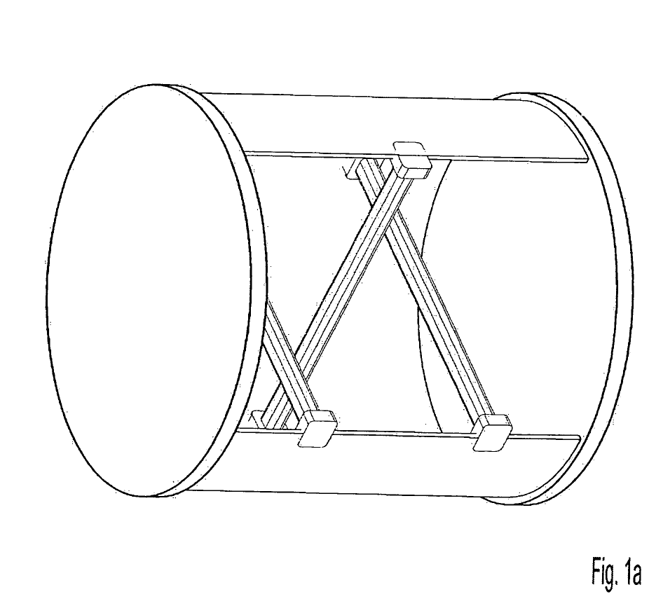

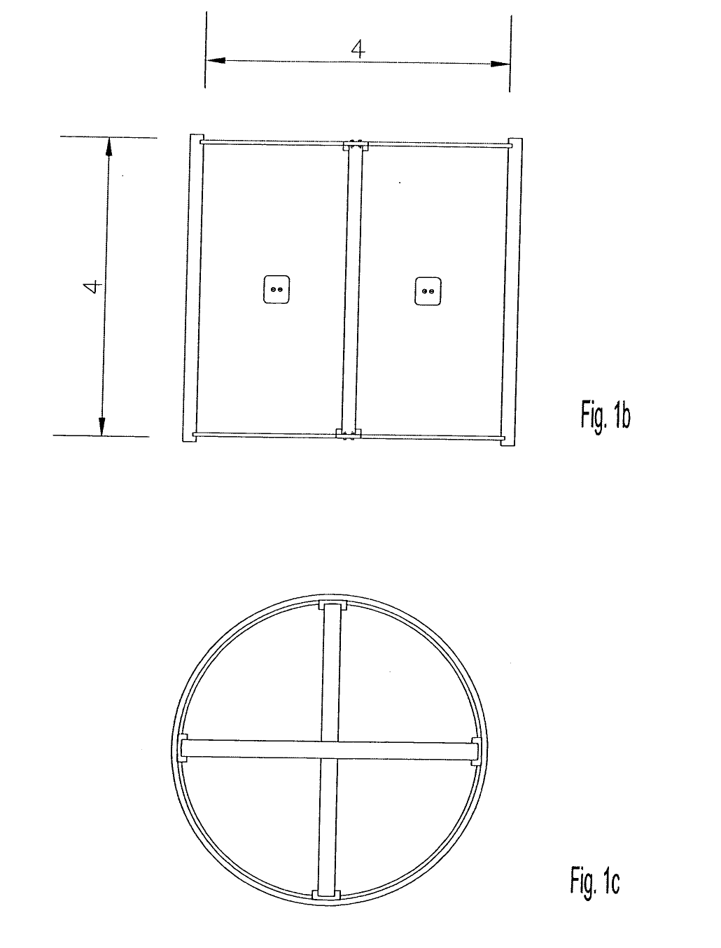

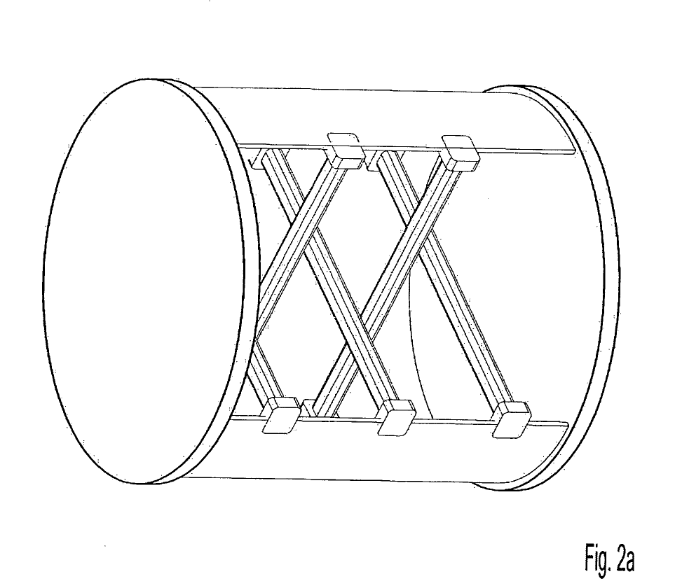

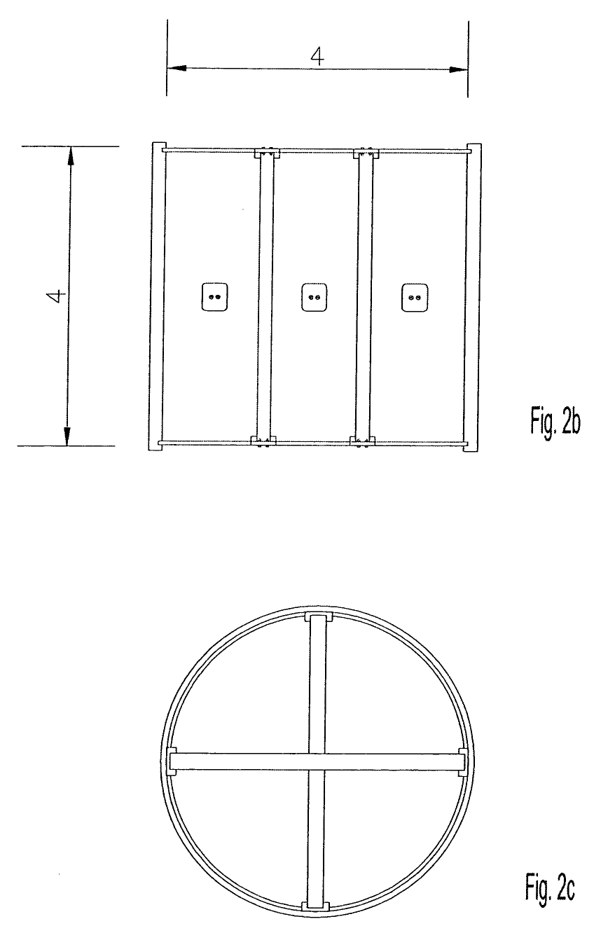

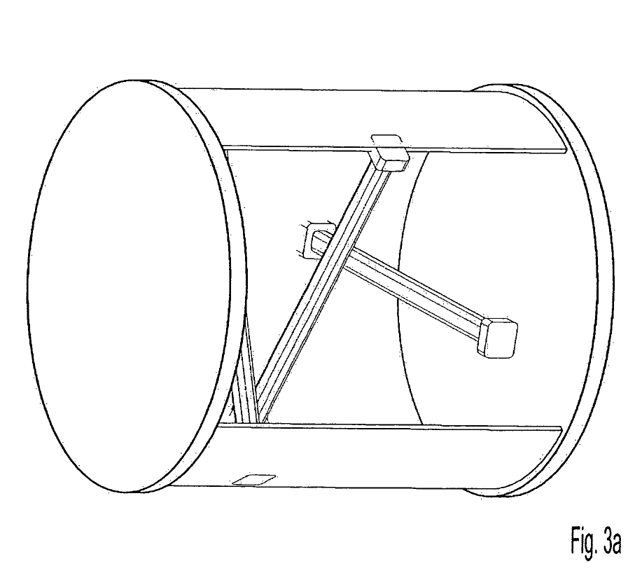

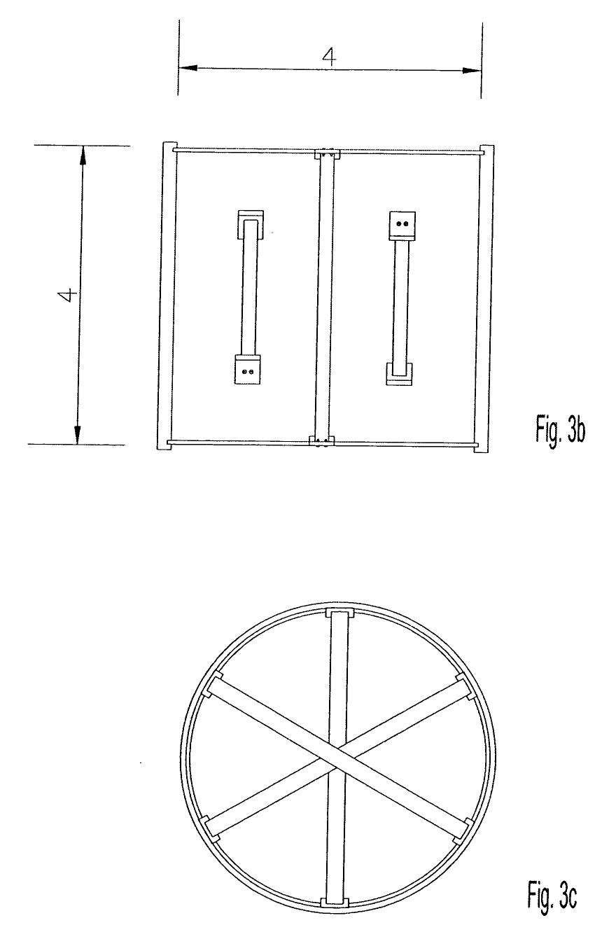

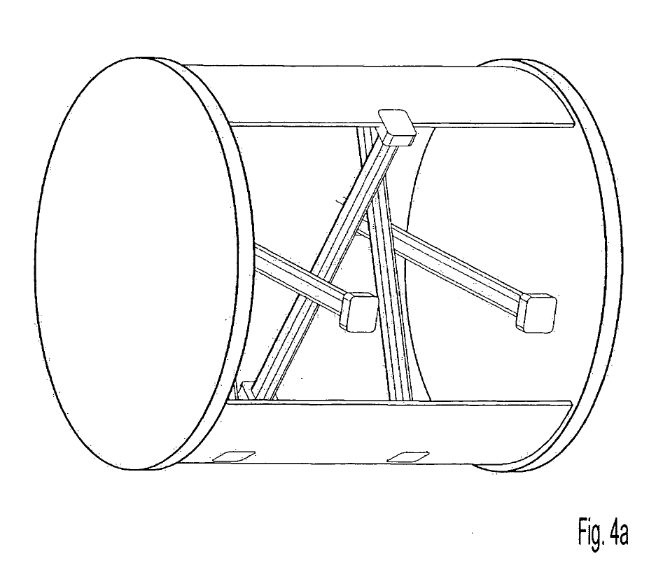

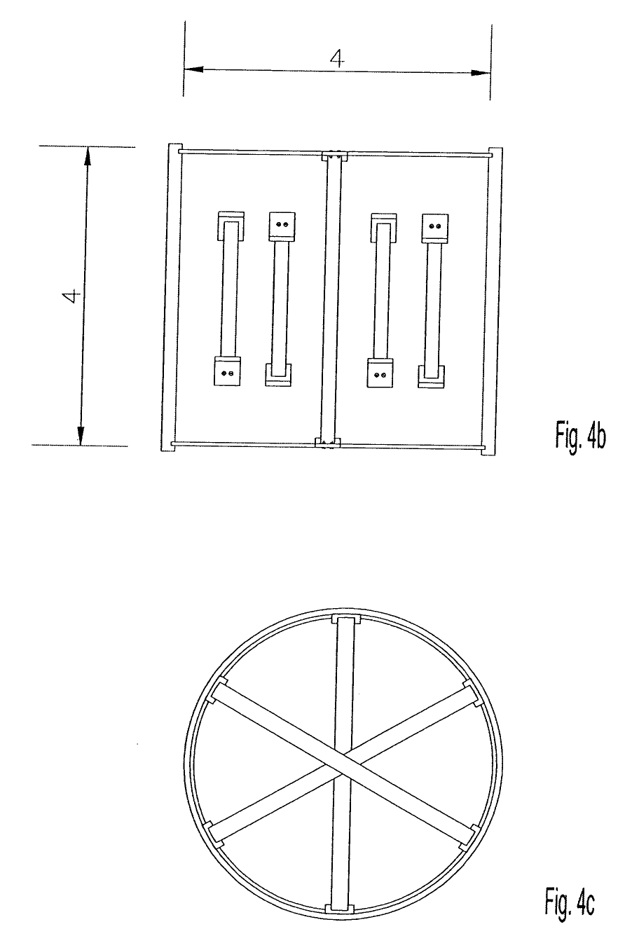

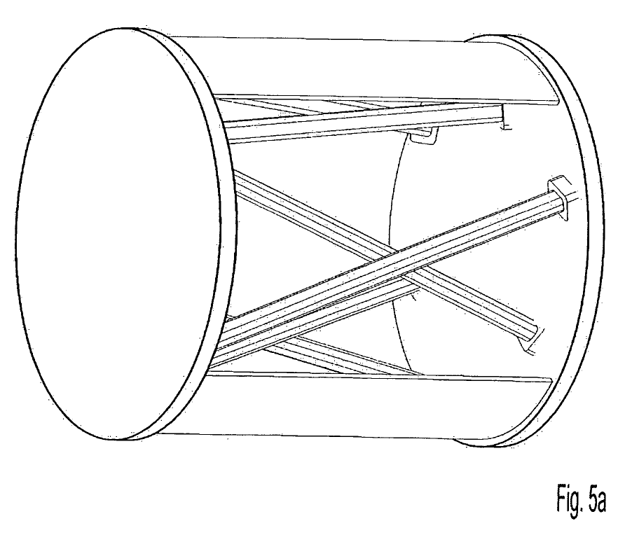

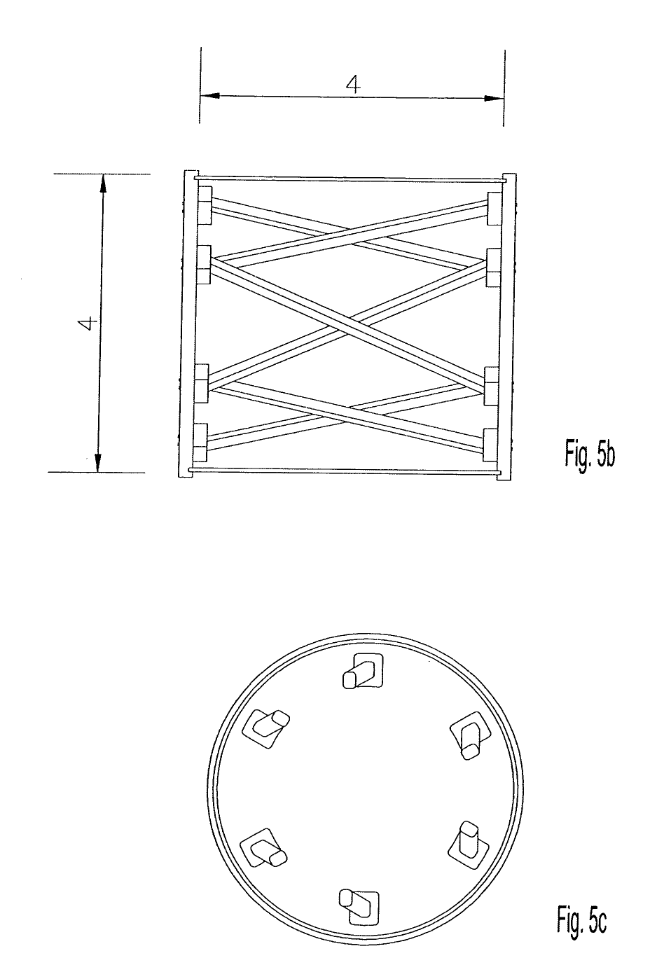

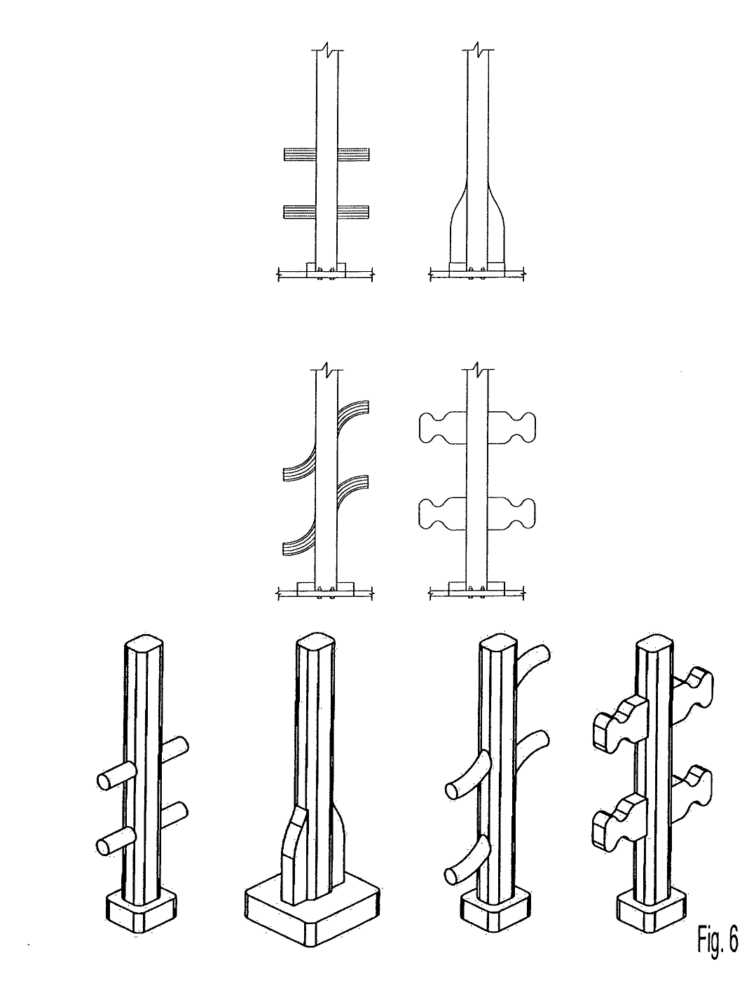

As shown in FIGS. 1-5 and FIG. 7 of the drawings attached for merely illustrative and not limitative purposes, the device of the present invention consists in a cylindrical vat made of wood, stainless steel, plastic or any other material that will resist the weight of its contents and also any chemicals introduced, the size of said cylindrical vat varying from 1 meter to 5 meters in diameter (sometimes even greater diameters) and varying also from approximately 1 meter to 5 meters in length.

The reactor is supported along its longitudinal axis and revolves on its axis at a speed of from 0.3 to 20 rpm, in both directions. Inside the reactor there is an arrangement of crosspieces of a length equivalent to the diameter of the cylinder, so as to generate mechanical action in operation.

As shown in FIGS. 1-5, the number, type and distribution of said crosspieces will vary according to reactor dimensions, the loads to which the device will be subject and the type of process intended on each occasion.

Subject to such circumstances, said arrangement may comprise different types of crosspieces, studs or rods (FIG. 6) cylindrical or rectangular in cross-section, or both at the same time, which may be geometrically homogeneous, may bear baffles, paddles or pins across them, according to the use for which device may be intended.

Depending on the requirements of use, said crosspieces may be arranged longitudinally (FIG. 5) to provide for special treatment processes.

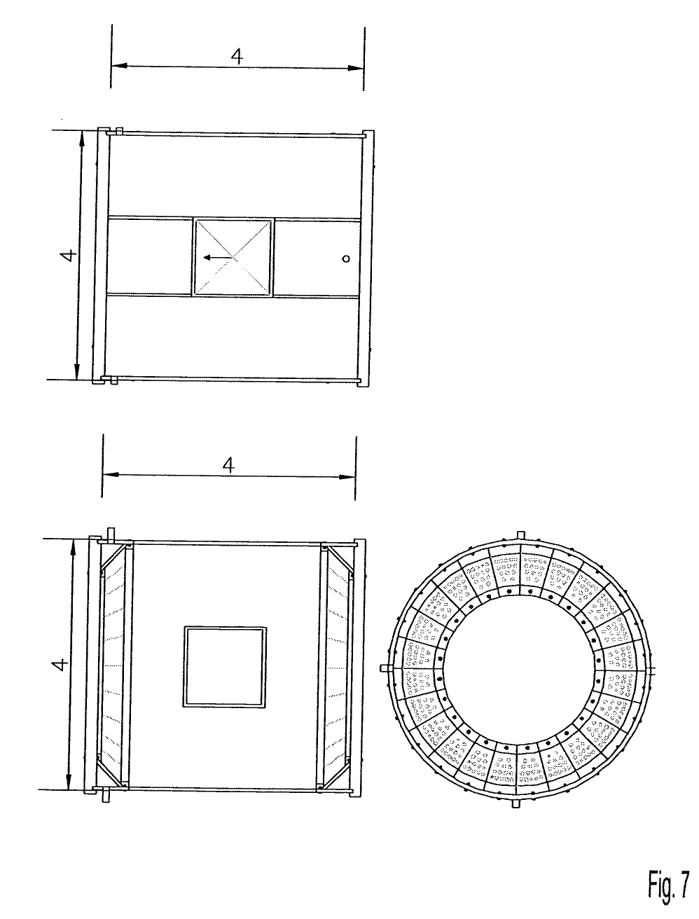

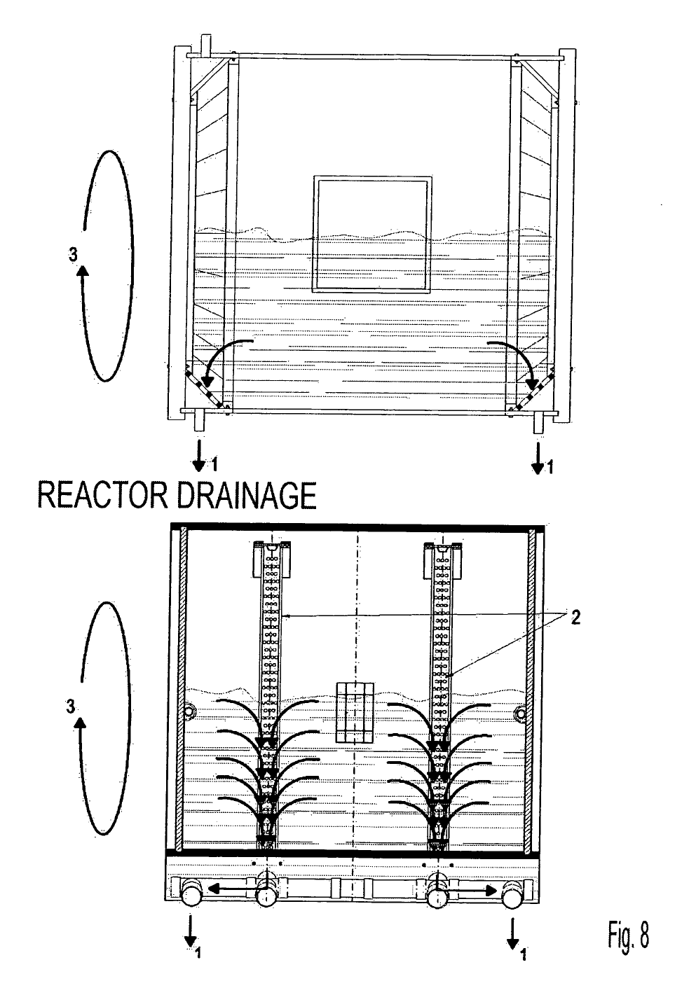

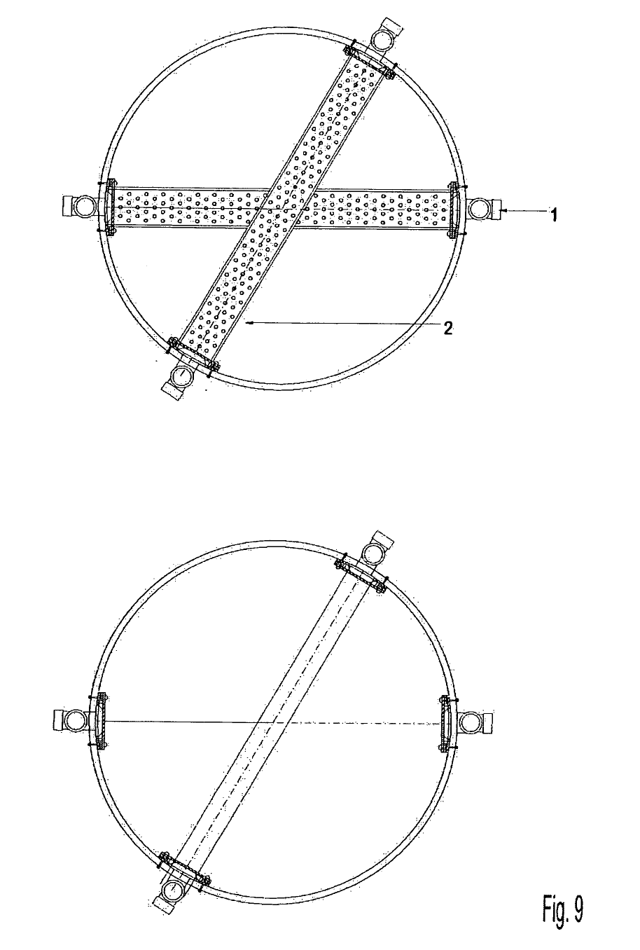

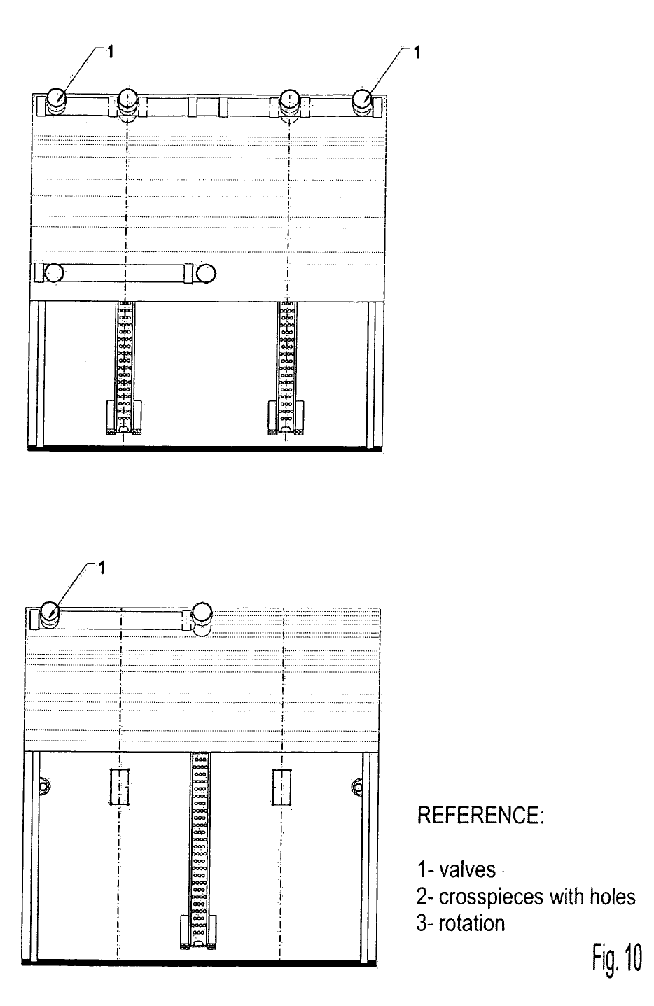

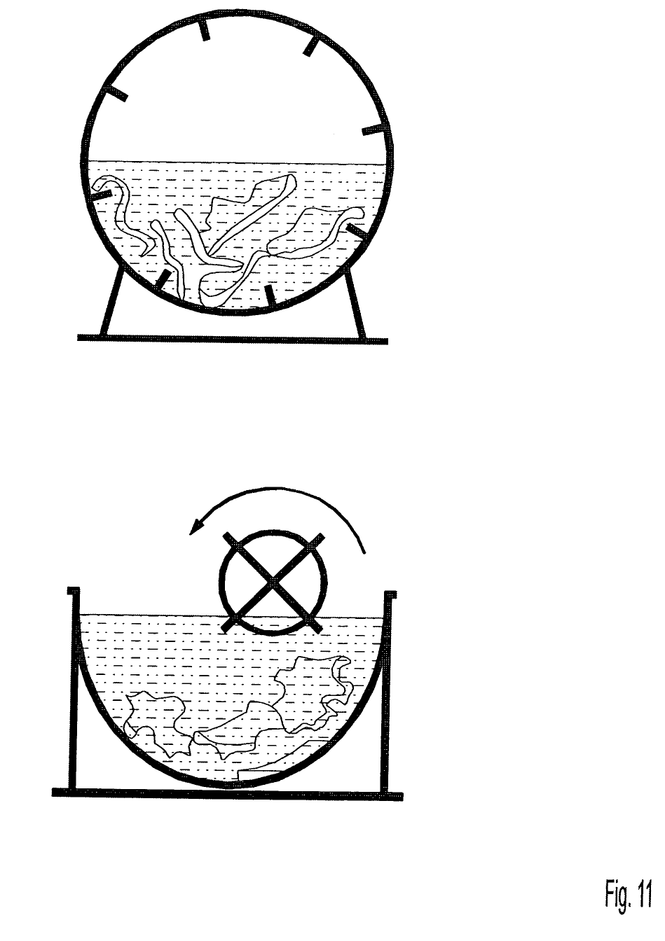

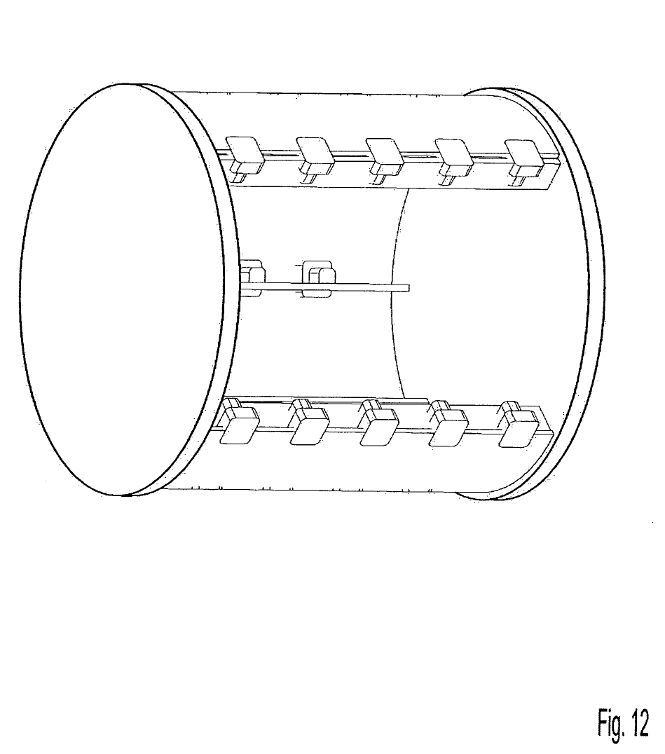

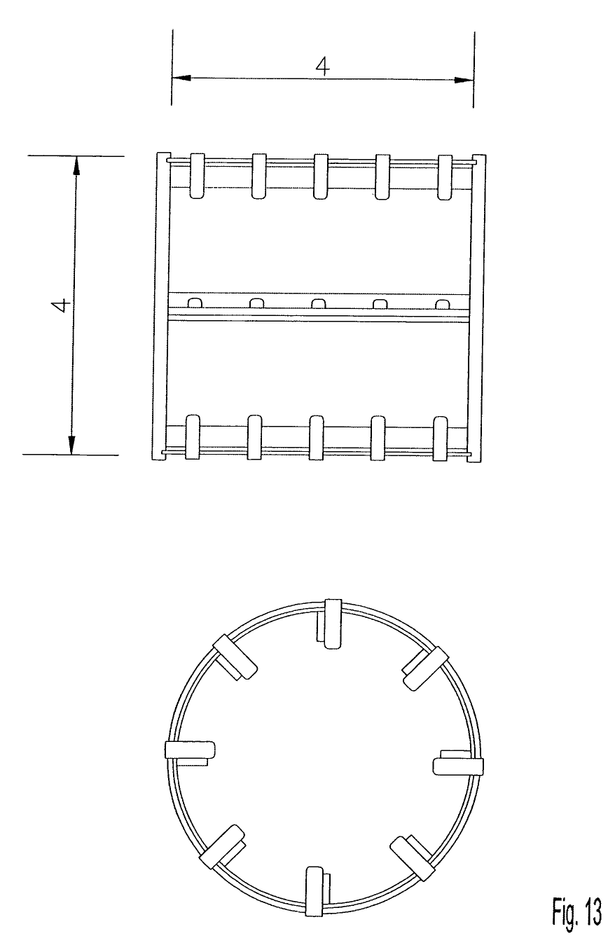

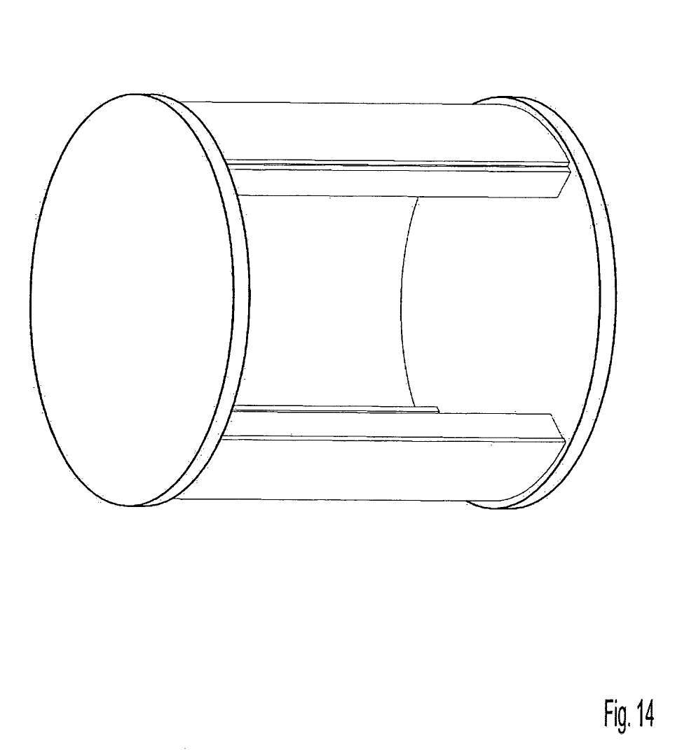

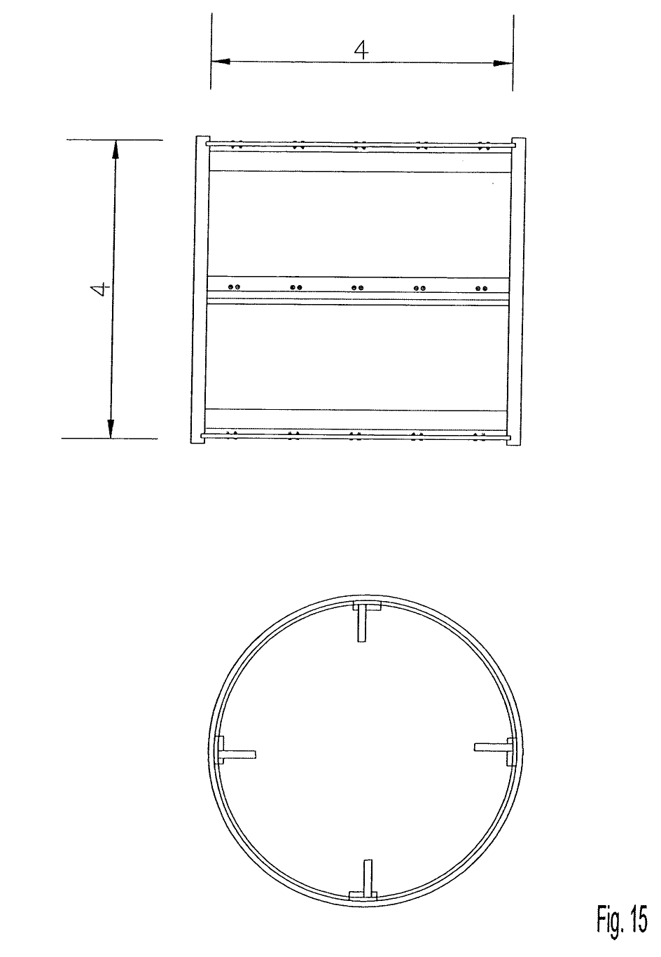

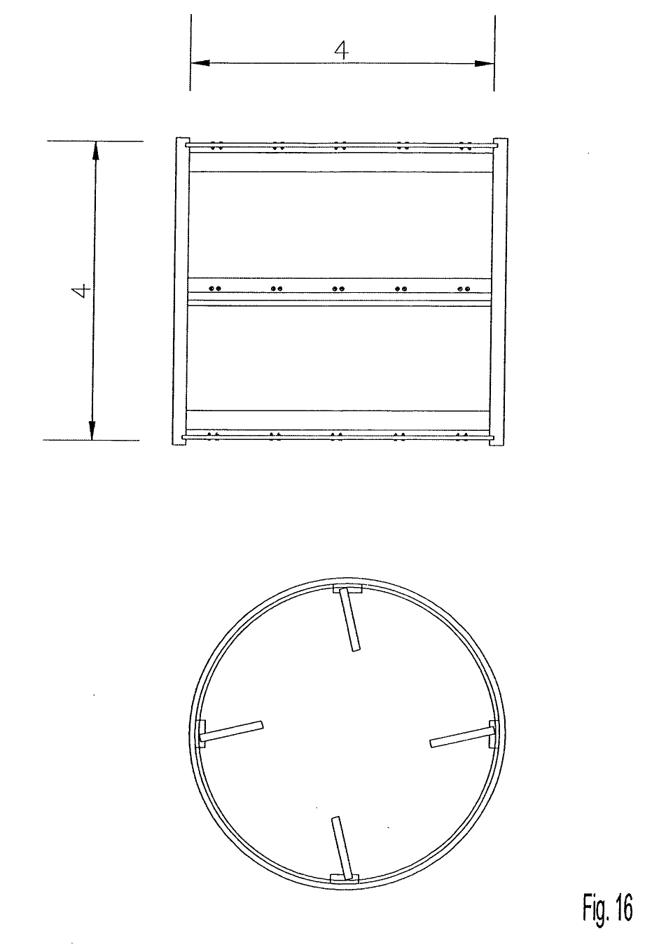

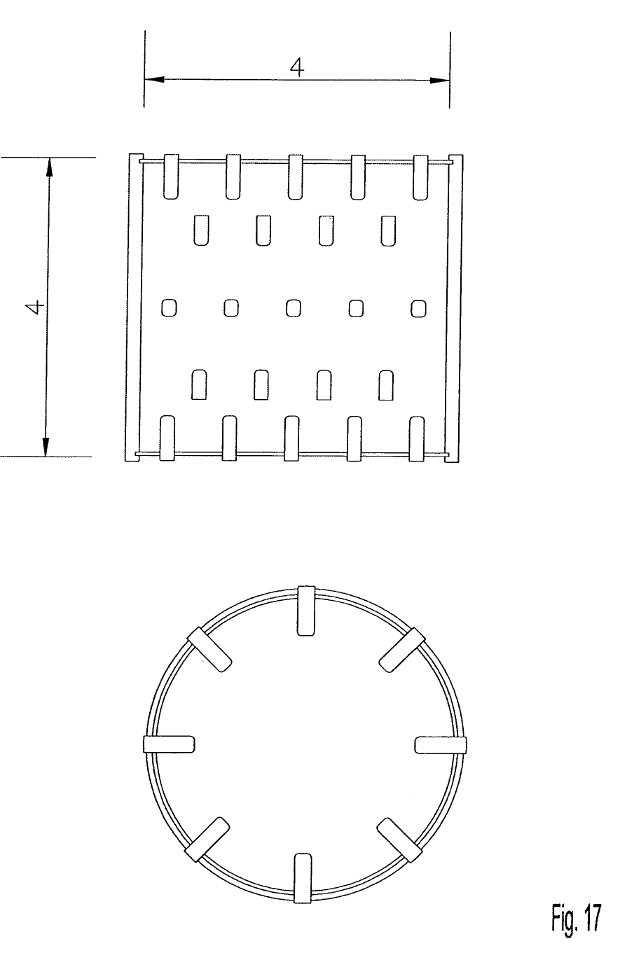

Finally (FIG. 7), the device is provided with gates for loading and unloading its contents, and with lattices and/or valves for the draining of resulting liquids.

1. A spiral system reactor for the treatment of hides and skins, said reactor having a cylindrically shaped body of a size equivalent to approximately five (5) meters in diameter and in length, said body rotating on its longitudinal axis.

2. The spiral system reactor for the treatment of hides and skins described in the preceding claims, providing inside said reactor an adequate number of crosspieces also varying in shape and arrangement according to the intended purpose of the process, which by means of mechanical motion perform steeping, scraping, pickling, tanning, retanning, currying, dyeing, dressing and beating activities on hides and skins.
